(19) United States
(12) Patent Application Publication
(10) Pub. No.: US 2003/0043183 A1
(43) Pub. Date: Mar. 6, 2003

(54) Image data provision system and image data provision method

(75) Inventors: Naoki Sakakibara, Tokyo (JP); Kenichi Sato, Tokyo (JP)

Correspondence Address: COLLARD & ROE, P.C., 1077 Northern Blvd., Roslyn, NY, 11576, US

(73) Assignee: Ability Cast Entertainment Co., Ltd

(21) Appl. No.: 10/187,667

(22) Filed: Jul. 2, 2002

(30) Foreign Application Priority Data
Aug. 31, 2001 (JP) 2001-264766

(51) Int. Cl. G09G 5/00

(52) U.S. Cl. 345/719

(57) ABSTRACT

An image data provision system includes: storage means which stores, in advance and in a related manner, motion picture data constituted of a collective of frames having a plurality of consecutive image data sets stored therein and stationary image data assigned to a plurality of the frames constituting the motion picture data; display means for playing back the motion picture data stored in the storage means; input operation means by way of which a user selects one frame from a plurality of frames constituting the motion picture data while viewing the motion picture data appearing on the display means; and control means which can provide the user with the stationary image data assigned to the frame selected by the selection means. As a result, stationary image data corresponding to a selected frame can be provided. For instance, if stationary image data which become inferior or superior in accordance with an input timing; that is, a shutter timing, are provided, a user can be provided with an entirely new entertainment element; that is, acquisition of better stationary image data aiming at a superior shutter timing.

### BACKGROUND OF THE INVENTION

1. Field of the Invention

The present invention relates to an image data transfer method which enables acquisition of image data according to a predetermined requirement or condition by way of a terminal while the terminal is connected with a server by way of a communication line such as the Internet. The present invention relates to a server capable of implementing the method.

More specifically, the present invention relates to an image data transfer method which enables acquisition of predetermined image data by way of (or through) a terminal, which is similar to photographing virtual models at a virtual shutter timing in a virtual photography contest (a game held for the purpose of giving photographers an opportunity to photograph models) held in a virtual studio on a WEB site. The present invention relates to a server capable of implementing the method.

2. Background Art

Photographing models with an actual camera or a photo competition for the best shot in a certain event have hitherto been performed often. In many cases, the best shot may be judged with balloting of a plurality of referees or by a professional cameraman.

In association with recent prevalence of the Internet, communication traffic per unit-hour has increased so that image data may be often distributed or delivered. In accordance with improvement of such an infrastructure, various entertainment services have become offered. For instance, a multiplayer game which is played while a plurality of terminals, such as personal computers, are connected to each other by way of a server has been adopted as a new type of game by many people in various countries, including the United States and Japan.

The present invention aims to apply the idea of photographing action set forth to a network or a global network, such as the Internet.

If an entertainment such as a contest for the best shot is applied to the Internet, the following have to be considered.

First, if motion picture data itself is used for the best shot by means of freezing the one scene of the motion picture data, the quality of the scene of the best shot may be lowered or the motion picture data should have a very large volume so that it takes too long to extract the data. In consideration of transmission speed, the quality of images must be degraded. However, if the quality of images is degraded, it can be readily predicted that players interested in photographing will be dissatisfied.

Second, a contrivance how to define the best shot of the motion picture is needed.

The present invention provides an image data transfer method for entertainment purpose which enables adaptation of an entertainment concept of photographing action to a network or a global network such as the Internet. The present invention provides a server capable of implementing the method.

### SUMMARY OF THE INVENTION

To consider the aforementioned, the present invention provides an image data provision system comprising: storage means which stores, in advance and in a related manner, motion picture data constituted of a collective of a plurality of frames having a plurality of consecutive image data sets stored therein and stationary image data assigned to each frame of a plurality of the frames constituting the motion picture data; display means for playing back the motion picture data stored in the storage means; input operation means by way of which a user selects one frame from a plurality of the frames constituting the motion picture data while viewing the motion picture data appearing on the display means; and control means which can provide the user with the stationary image data set assigned to the frame selected by the input operation means.

When the image data provision system is constructed so as to be utilized while connected to a network or a global network, such as the Internet, the display means corresponds to display means of a terminal, such as a personal computer connected to a global network such as the Internet. Further, the input operation means corresponds to a keyboard, joystick, or mouse of the personal computer.

In accordance with the present invention, when motion picture data are displayed on the terminal, the motion picture data may be temporarily downloaded into the terminal. The present invention can also be applied to a case where the motion picture data are displayed in real time on the terminal while being transmitted to the same.

Further, when the image data provision system is constructed so as to be utilized while it is connected to a network or a global network, such as the Internet, in the manner set forth, the motion picture data may comprise image data including a still image data set having a smaller volume of data than a stationary data set of the stationary image data (e.g., an image having a smaller number of colors and lower dot density) in order to prevent occurrence of a low or slow transmission rate or unauthorized use of the motion picture data.

The present invention provides an image data provision system comprising: storage means which stores, in advance and in a related manner, motion picture data constituted of a collective of a plurality of frames having a plurality of consecutive image data sets stored therein and stationary image data assigned to each frame of a plurality of the frames constituting the motion picture data; display means for playing back the motion picture data stored in the storage means; input operation means by way of which a user selects one frame from a plurality of frames constituting the motion picture data while viewing the motion picture data appearing on the display means; and control means which can provide the user with the stationary image data set assigned to the frame selected by the input operation means.

According to the present invention, the motion picture data is played back by means of the display means, and a user performs an input operation at a timing which is considered to be the best for the motion picture data, by way of the input operation means. Stationary image data corresponding to the operation timing are extracted by the control means. There can be provided an environment in which contestants compete with each other for best shots in an actual photography contest. The present invention can be realized by means of a distributed system in which the display means, the input operation means, the storage means, and the control means are disposed in different locations and remotely operated by way of the input operation means. For instance, the invention can be embodied as one system, in which startup means, such as a coin selector, and the control means are connected together, and playback of motion picture data is allowed on condition that the user has inserted a predetermined value of coins into the startup means. When the present invention is embodied in the form of a single system, it is predicted that the system will be disposed as an amusement machine in an amusement facility, such as an amusement arcade. Here, the expression “motion picture data are stored beforehand in association with stationary image data corresponding to a plurality of frames constituting the motion picture data” refers to the following. Specifically, as will be described in embodiments, each frame of the motion picture data is associated with each stationary data set of the stationary data such that a corresponding stationary image data set can be extracted by use of a lookup table by way of electronic data for associating a frame of the motion picture data with a corresponding stationary image data set of the stationary image data.

In another aspect of the present invention, an image data provision system is provided, wherein motion picture data are played back through remote operation of the input operation means by way of a network or a global network (hereafter described “a global network”). When the input operation means is operated at a predetermined timing, one frame is selected from a plurality of frames constituting the motion picture data. A stationary image data set of the stationary image data corresponding to the thus-selected frame can be obtained.

Yet in another aspect of the present invention, an image data provision system which can send motion picture and stationary image data in accordance with remote operation by a user by way of a terminal, through a global network such as the Internet, comprises: storage means which stores, in advance, motion picture data constituted of a collective of a plurality of frames having a plurality of consecutive image data sets stored therein and stationary image data assigned to each frame of a plurality of the frames constituting the motion picture data; communication means which sends motion picture data stored in the storage means to the terminal in response to receipt of a playback request signal from the terminal and which can display the motion picture data on display means of the terminal; and control means which can display the motion picture data on the display means of the terminal, receives a selection input signal for selecting one frame from a plurality of the frames constituting the motion picture data by way of the communications means, selects the frame to be selected in accordance with the receiving timing of the selection input signal, and transmits to the terminal the stationary image data associated with the frame.

According to the present invention, the image data provision system transmits motion picture data stored in the storage means to one or a plurality of user terminals connected to the system by way of the global network, on condition that the system receives a playback request signal from at least one terminal. The thus-played-back motion picture data is played back on display means of the terminal. Simultaneously, upon receipt of a selection input signal serving as a virtual shutter timing, the system transmits to the terminal(s) stationary image data corresponding to a frame of the motion picture data. Thus, users of the terminals can be provided with a virtual photography contest.

In another aspect of the present invention, stationary image data assigned to a plurality of frames constituting the motion picture data need not be image data identical with the frames set forth; one set of stationary image data may be constructed so as to correspond to a plurality of frames. More specifically, a user transmits a virtual timing while viewing the motion picture data. The control means determines one frame from the plurality of frames constituting the motion picture data, in accordance with the operation performed by way of the input operation means and in accordance with the selection input signal received by way of the communications means. It may also be possible to constitute the system such that the control means performs control operation so as to extract stationary image data which are smaller in volume than that of the plurality of frames corresponding to the thus-determined frames, to thereby display the data on the display means or to the terminal. By means of such a construction, ranking evaluations corresponding to the virtual shutter timings are prepared beforehand, by means of changing contents of stationary image data. For example, when a user has transmitted a good shutter timing, there may be provided stationary image data pertaining to a rare photograph of a famous talent. In contrast, when a user has transmitted a poor shutter timing, there may be provided stationary image data expressing regrets. Thus, the gaming element of the system can be further enhanced.

In another aspect of the present invention, when one frame has been selected from the motion picture data constituted of the collective of a plurality of frames in accordance with an operation performed by way of the input operation means and in accordance with the selection input signal received by way of the communications signal, the control means performs control operation for extracting one set of stationary image data previously assigned to the selected frame, from stationary image data sets which are smaller in number than the plurality of the frames.

In another aspect of the present invention, in order to prevent occurrence of a transmission rate lagging behind a rate for playing back motion picture data, which would otherwise arise when motion picture data are transmitted and received over the Internet, image data in the form of the frame are of low quality such that the image data can be subjected to processing, such as transmission, faster than processing to which the stationary image data are subjected.

In another aspect of the present invention, an image data provision method comprises the steps of: displaying motion picture data constituted of a collective of a plurality of frames corresponding to a plurality of previously-stored consecutive image data sets; performing an input operation by a user at a desired timing while viewing the displayed motion picture data; selecting one frame from the plurality of frames at the input timing; and extracting stationary image data corresponding to the selected frame from among a plurality of previously-prepared stationary image data sets.

In another aspect of the present invention, an image data provision method which can transmit motion picture and stationary image data over a global network, such as the Internet, in accordance with remote operation performed by a user by way of a terminal, comprises the steps of: storing, in advance, motion picture data constituted of a collective of a plurality of frames having a plurality of consecutive image data sets stored therein and stationary image data assigned to each frame of a plurality of the frames constituting the motion picture data; transmitting the stored motion picture data so as to display the same on the terminal in response to receipt of a playback request signal from the terminal; receiving a selection input signal for selecting one frame from a plurality of frames constituting the motion picture data; and transmitting to the terminal stationary image data assigned to each frame of the frame corresponding to a timing at which the selection input signal is received.

In another aspect of the present invention, when one frame has been selected from the motion picture data constituted of the collective of a plurality of frames in accordance with an operation performed by way of the input operation means and in accordance with the selection input signal received by way of the communications signal, one set of stationary image data previously assigned to the selected frame is extracted from stationary image data sets which are smaller in number than the plurality of the frames.

In another aspect of the present invention, image data in the form of a frame are of low quality such that the image data can be subjected to processing, such as transmission, faster than processing to which the stationary image data are subjected. The present invention prevents occurrence of a low processing rate, such as a communication speed.

In another aspect of the present invention, an image processing system comprises the image data provision system set forth, wherein the image data provision system is a WEB server connected to a global network, such as the Internet, to which a plurality of the terminals can be connected; and wherein the WEB server comprises: storage means for storing a plurality of receiving timings pertaining to the same motion picture data transmitted from the terminals; and control means which selects and processes the terminal that has transmitted a receiving timing suitable for a predetermined requirement or condition from among a plurality of the receiving timings stored in the storage means.

In another aspect of the present invention, an image data provision method which can transmit motion picture and stationary image data over a global network, such as the Internet, in accordance with remote operation performed by a plurality of users by way of terminals, comprises the steps of: storing, in advance, motion picture data constituted of a collective of a plurality of frames having a plurality of consecutive image data sets stored therein and stationary image data assigned to each frame of a plurality of the frames constituting the motion picture data; transmitting the stored motion picture data so as to display the same on the terminal in response to receipt of a playback request signal from one of the terminals; receiving a selection input signal for selecting one frame from a plurality of frames constituting the motion picture data; transmitting to the terminal stationary image data assigned to the frame corresponding to a timing at which the selection input signal is received; storing a receiving timing corresponding to the motion picture data; and comparing the stored receiving timing with receiving timings pertaining to the same motion picture data sets transmitted from other terminals, thereby selecting a terminal which has transmitted a receiving timing at a timing most suitable for a predetermined requirement.

In another aspect of the present invention, an entertainment element is provided so as to enable users at a plurality of terminals to compete with each other for a receiving timing (virtual shutter timing) pertaining to the same motion picture data.

Provided that superiority and inferiority of selection of a frame have been determined beforehand for each of frames serving as a plurality of image data sets constituting the motion picture data, a giveaway corresponding to the selectively-input frame can be provided to the user who has selected the frame. Thereby, the entertainment element can be improved to a much greater extent.

According to the invention set forth, from among motion picture data which can be expressed in an animated manner by means of consecutive display of a plurality of image data sets, stationary image data corresponding to the image data can be provided in accordance with an input timing at which the user has performed an input operation (i.e., shutter input). Therefore, a so-called photography contest can be provided virtually.

### BRIEF DESCRIPTION OF THE DRAWINGS

FIG. 1 is a schematic representation showing the configuration of a communication line network according to the present invention;

FIG. 2 is a block diagram showing the configuration of a personal computer serving as a WEB terminal according to the present invention;

FIG. 3 is a block diagram showing the configuration of a server according to the present invention;

FIG. 4 is a descriptive diagram showing the relationship between the frame and click points according to the present invention;

FIG. 5 is a flowchart showing an example of an image data provision method using a global network, such as the Internet, having the present invention applied thereto;

FIG. 6 is a flowchart showing another example of an image data provision method using a global network, such as the Internet, having the present invention applied thereto;

FIG. 7 is a flowchart showing yet another example of an image data provision method using a global network, such as the Internet, having the present invention applied thereto; and

FIG. 8 is a block diagram showing a modification of an image data provision system having the present invention applied thereto.

### DETAILED DESCRIPTIONOF THE PREFERRED EMBODIMENTS

By reference to drawings, there will now be described an image data provision system 1 to which the present invention is applied and which is embodied as a virtual photography contest using a global network, such as the Internet.

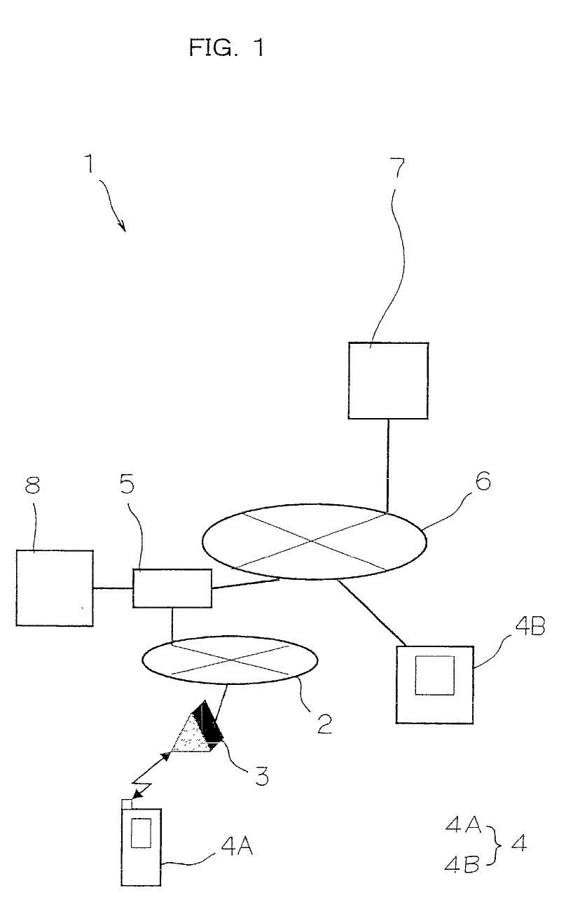

FIG. 1 shows an image data provision system according to the present invention which enables presentation of a virtual photography contest using a global network, such as the Internet. The image data provision system comprises a WEB server 7; a WEB terminal 4; a packet network/PDC (personal digital cellular) network 2; a cell site 3; an information center 5; and the Internet 6. The WEB terminal 4 is connected to the server 7 and receives motion picture data and stationary image data from the server 7. Further, the WEB terminal 4 enables a contestant to perform an input operation at a virtual shutter timing with respect to the server 7. The packet network/PDC network 2 mediates between the WEB server 7 and the WEB terminal 4.

The WEB terminal 4 comprises a portable cellular phone 4A and a stationary terminal 4B, such as a personal computer. Each of the portable cellular phone 4A and the terminal 4B is provided with display means 14, respectively.

Portable cellular phones 4A, 4A, . . . owned by an indefinite number of users are connected to the image data provision system 1 shown in FIG. 1 and to the packet network/PDC network 2 via the cell site 3. Similarly, personal computers 4B owned by an indefinite number of users are connected to the Internet 6. The user terminals 4, such as the portable cellular phones 4A and the personal computers 4B, can exchange sound and character data with each other via a communication line network, such as the packet network/PDC network 2 and the Internet 6, by means of, for example, a TDMA (time-division multiple access) system.

In addition to exchanging sound, character, or image data, the portable cellular phone 4A can access the information center 5 via the packet network/PDC network 2 by means of packet communication. In response to a request from the portable cellular phone 4A, the information center 5 acquires various information items from the server 7 connected to the Internet 6 or from the server 8 connected to the information center 5 via a private line. The information center 5 passes the thus-acquired information to the portable cellular phone 4A that has originated the request. Thus, the user of the portable cellular phone 4A can acquire desired information from the server 7 without regard to his/her location, even when outdoors and away from home.

The personal computer 4B can acquire various information items from the server 7 connected to the Internet 6, via the Internet 6.

The global network according to the present invention corresponds to the packet network/PDC network 2, the cell site 3, the information center 5, or the Internet 6.

Here, any type of terminal can be adopted in the present invention; e.g., the portable cellular phone 4A and the personal computer 4B, or another type of display-screen-equipped terminal.

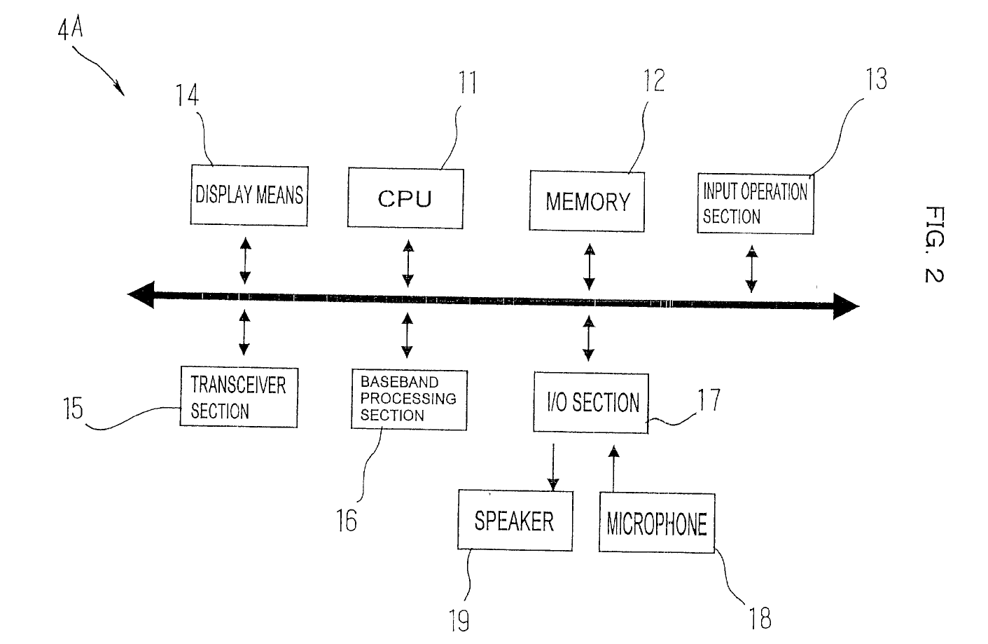

FIG. 2 is a block diagram showing the configuration of the portable cellular phone 4A serving as a terminal owned by the user. As shown in FIG. 2, the portable cellular phone 4A comprises a data BUS. The data BUS is connected to a CPU 11; a memory 12; a transceiver section (RF) 15 for exchanging a signal with the cell site 3; a baseband processing section 16; an I/O section 17 which is an interface equipped with a microphone 18 and a speaker 19 and acts as a sound processing section; display means 14 constituted of a liquid-crystal display panel; and an input operation section 13 (as an example of the input operation means) such as a keyboard or a jog dial. Here, the baseband processing section 16 converts an RF (radio frequency) signal received by the transceiver section 15 into a baseband signal and converts into an RF signal a baseband signal intended to be transmitted.

The CPU 11 performs various operations in accordance with an operation program stored in the memory 12 and controls individual circuit sections in accordance with the operations. Details of processing to be performed by the CPU 11 are displayed on the display means 14, as required.

When the user inputs a phone number of a desired party or performs a selection input operation at a virtual shutter timing to be described later, the input operation section 13 supplies the phone number to the CPU 11 in the case where data representing a phone number having been input. The CPU 11 then sends a connection request to the party represented by the phone number input by the user, via the transceiver section 15. In the case of the selection input operation having been performed, a selection input signal is transmitted to the server 7.

When a phone number has been input as mentioned above, a line is connected in response to an answer from the called party via the packet network/PDC network 2. When the line has been connected, the transceiver section 15 supplies the RF signal received from the called party via the antenna to the baseband processing section 16, where the RF signal is converted into a baseband signal. The baseband processing section 16 supplies the thus-converted baseband signal to the I/O section 17. In this way, the sound signal received from the called party is output as sound from the speaker 19.

When the user inputs his/her sound by way of the microphone 18, the I/O section 17 supplies the input sound signal supplied by the microphone 18 to the baseband processing section 16, whereby the baseband signal is converted into an RF signal. The baseband processing section 16 transmits the thus-converted RF signal to the packet network/PDC network 2 via the transceiver section 15. As a result, the RF signal is transmitted to the called party who was line-connected to the packet network/PDC network 2. Thus, the user possessing the portable cellular phone 4A can communicate with another user; that is, the called party, via the portable cellular phone.

After having converted, into packet data, various information items (e.g., character data or specific selection information etc.) input as a result of the user manipulating of the input operation section 13, the CPU 11 transmits the thus-converted packet data to the packet network/PDC network 2 via the baseband processing section 16 and the transceiver section 15. The packet network/PDC network 2 sends the packet data to the information center 5. The RF signal—on which is superimposed the information having been converted into packet data and sent from the information center 5 by way of the packet network/PDC network 2—is taken into the CPU 11 by way of the transceiver section 15 and the baseband processing section 16, and thus the RF signal is displayed on the display means 14.

Thus, the user possessing the portable cellular phone 4A can receive various services offered by the server 7 by way of the called party; that is, the information center 5.

Hardware configuration of the personal computer serving as the terminal 4B owned by the user is for playing a role required as the WEB terminal 4 and is analogous to that of the portable cellular phone 4A. Hence, explanations of the hardware configuration of the personal computer are omitted.

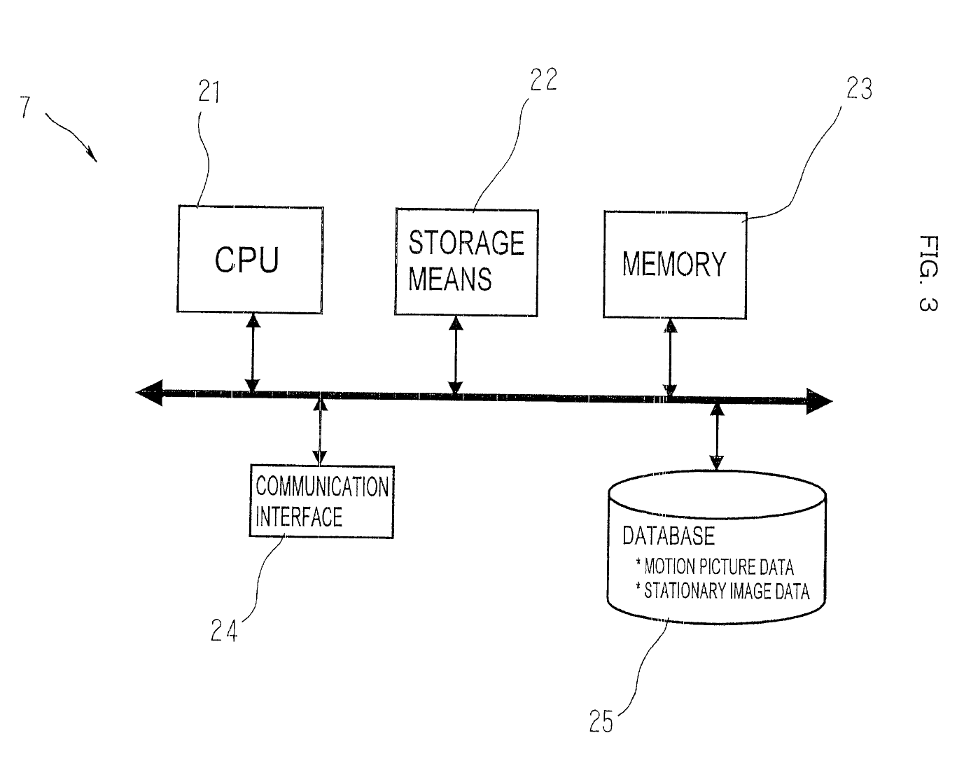

FIG. 3 is a block diagram showing the configuration of the server 7. As shown in FIG. 3, the server 7 comprises a CPU 21 connected to the data BUS; storage means 22 such as a hard disk; a memory 23; a communication interface 24, and a database 25. In accordance with a control program stored in the memory 23, the CPU 21 performs various types of processing operations. More specifically, the CPU 21 receives phone calls transmitted from respective portable cellular phones 4A by way of the Internet 6 connected to the communication interface 24, as well as receiving input information from the personal computer 4B. The thus-received phone calls and input information are stored in the storage means 22.

The storage means 22 stores as a control program a progress program pertaining to a virtual photography contest, as well as individual member information items. Previously registered in the member information are receiving timings corresponding to the signals input as a result of manipulation of the input operation sections 13 of the terminals 4 and corresponding to timings at which motion picture data are to be played back. The control means (by way of example CPU 21 is shown in FIG. 3.) sends, to the terminals 4, motion picture data representing a virtual photography contest which is to proceed in accordance with the program. Further, the control means extracts, from the database 25, stationary image data previously associated with respective frames, the respective frames acting as image data selected on the basis of data pertaining to the receiving timings received from the terminals 4. The control means performs control operation so as to transmit the thus-extracted stationary image data to the terminals 4.

Previously stored in the database 25 is a lookup table for associating a plurality of frames serving as the image data stored in the database 25 with the stationary image data.

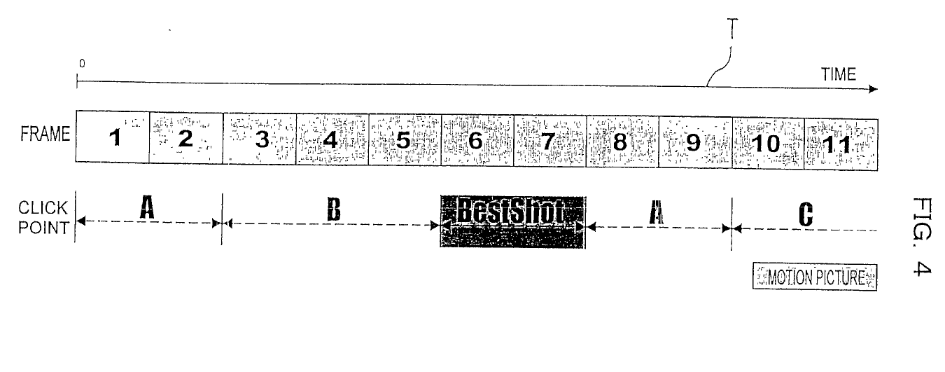

For instance, as shown in FIG. 4, the horizontal axis represents a time T required for playing back motion picture data. Motion image data are displayed in an animating manner by means of consecutively displaying image data pertaining to frames 1 through 11 on the display means 14 of each terminal 4. The lookup table stored in the database 25 allocates stationary image data A to frames 1 and 2; stationary image data B to frames 3 through 5; best shot frames to frames 6 and 7; frame A—analogous to that assigned to the frames 1 and 2—to frames 8 and 9; and frame C to frames 10 and 11.

The memory 23 temporarily stores electronic data received from the portable cellular phones 4A, 4A, . . . owned by users and from the personal computers 4B, 4B, . . . owned by other users.

Required screen information to be sent to the terminals 4, such as registration screen information pertaining to personal information or initial screen information, is stored in the database 25.

Next, flow of provision of image data pertaining to the virtual photography contest to which the present invention is applied will now be described by reference to a flow chart. Outline of the virtual photography contest will first be described.

(Outline)

A virtual studio is built on a WEB site in the server 7, and a model photography contest is held in the virtual studio as the virtual photography contest.

The contestant selects the type of a motion picture; that is, a desired model, by means of accessing the server 7 acting as a site by way of the terminal 4.

While viewing the thus-selected motion picture by the terminal 4, the contestant virtually photographs an object, by means of clicking a shutter button prepared on a home page of the site, by way of the input operation section 13 of the terminal 4.

After playback transmission of the motion picture has been completed, data pertaining to photographed frames are stored in the server 7. In this case, when all the motion picture data are played back by the terminal 4 after having been downloaded, the photographed frames or identification information about the frames are sent to the server 7.

Stationary image data (having a picture quality of, e.g., 640×480 JPEG foramt) corresponding to image data pertaining to the photographed frames can be downloaded (transmitted) to the terminal 4.

The motion picture data comprise a plurality of best shots. When the contestant has performed an input operation for photographing one of the best shots, downloading (transmission) of image data with a premium becomes possible.

Five shots can be taken for one game, and stationary image data photographed at respective timings can be downloaded.

Entry into the virtual photography contest is on a chargeable basis, and the charge for one service is 200 Japanese yen.

If all image data with premiums with regard to single motion picture data are collected, the contestant is granted a right to acquire an item with a super premium.

Since the terminal 4 adopts a method which enables input of a shutter timing through clicking of a mouse, the personal computer 4B is adopted as a terminal.

In the present embodiment, setting is effected such that the photography contest is to be terminated when five shots have been taken in one game. However, setting may also be effected such that image data frames or stationary image data, which are portions of the motion picture data obtained through five shooting actions, may be retaken up to three times. A known technique adopted in a seal photographing machine, such as a Print Club (by Atlas Corporation), can be diverted to retaking.

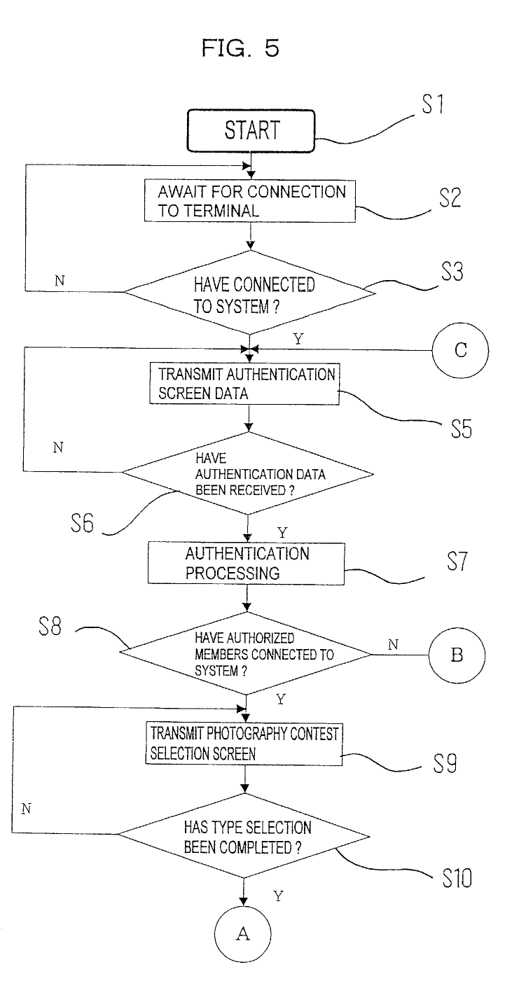

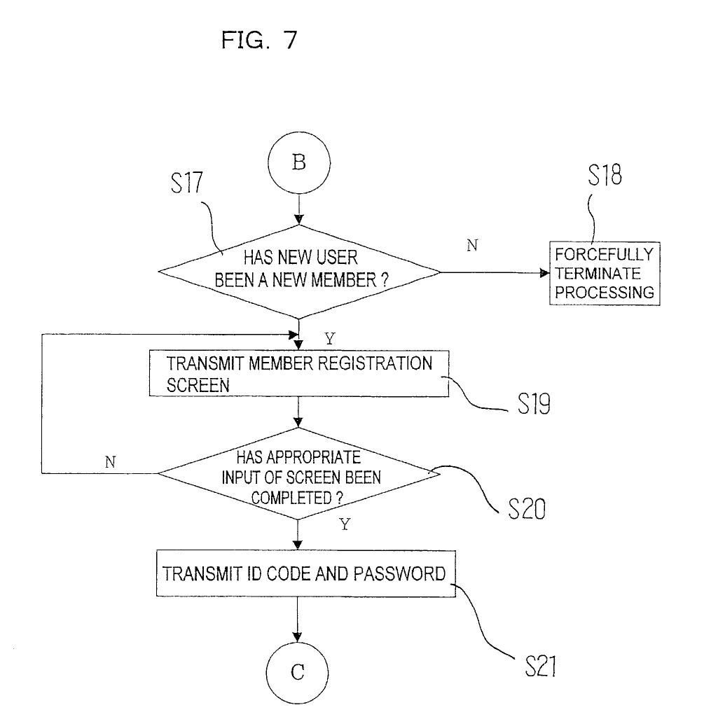

A flow of provision of image data pertaining to the virtual photography contest, which has been described briefly, will now be described in detail by reference to FIGS. 5 through 7.

The server 7 is booted for establishing connection with the global network, such as the Internet 6 (step S1), and enters a standby condition until the terminal 4 establishes connection with the server 7 by way of the global network (step S2).

A determination is made as to whether or not the terminal 4 has made an access to the server 7. If an access is determined to have been made (when YES is selected in step S3), authentication screen data are transmitted (step S5). The authentication screen data are stored beforehand in the database 25 of the server 7.

In connection with the transmitted authentication image data, completion of input of a password and an ID code, serving as authentication information, performed by the input operation section 13 of the terminal 4 is awaited. When the control means of the server 7 has determined that the authentication information has been received (when YES is selected in step S6), the ID code and the password registered in the individual member information previously stored in the control means of the server 7 or the storage means 22 are compared with the received ID code and password, thus performing an authentication operation (step S7).

When the control means of the server 7 determines that a true user has made an access, on the basis of a result of authentication (when YES is selected in step S8), screen data pertaining to selection of type of photography contest in which the server 7 can provide are transmitted (step S9). In the embodiment, two types of photography contests are provided: (1) capturing the moment of her smile from images based on motion picture data pertaining to a race queen who is walking around; and (2) capturing the moment of crash or finish from images based on motion picture data pertaining to a car race.

When the control means of the server 7 has determined completion of type selection, by means of receiving selection of a type on the transmitted type selection screen (when YES is selected in connection with completion of type selection), the control means of the server 7 performs billing operation on the basis of credit data or a telephone bill stored beforehand as individual member registration information (step S6). Motion picture data of selected type are transmitted to the terminal 4. Motion picture data of one type is selected on the type selection screen through input operation of the input operation section 13 of the terminal 4. The signal transmitted from the terminal 4 to the server 7 as a result of selective input operation set forth corresponds to a playback request signal.

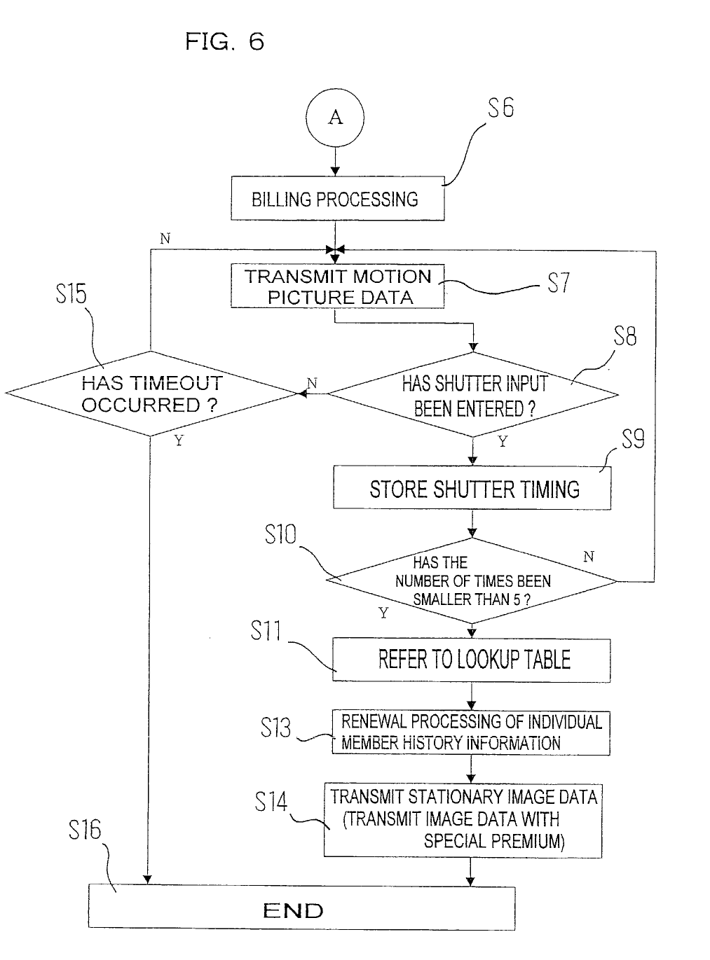

Motion picture images based on the motion image data are played back on the display means 14 of the terminal 4. While viewing a motion picture image, the user performs a selection operation by way of the input operation section 13 at good timing (when YES is selected in step S8). Selection input operation corresponds to clicking of the shutter button or a shutter timing shown in FIG. 6. An operation input signal produced as a result of input operation is transmitted to the CPU 11 serving as control means of the terminal 4 or to the CPU 21 serving as control means of the server 7.

The motion image data are constituted of a frame collective comprising a plurality of digital image data sets. A motion picture image is played back, by means of displaying the frames through consecutive switching. One of the displayed frames is selected at the timing selected through input operation, and the frame is stored as shutter timing (step S9).

Although the present embodiment is not limited to the shutter timing set forth, a program is set such that the contestant can select shutter timing up to five times (when YES is selected in step S10) until a time over at which playback of the motion picture image is completed (step S15).

In order that stationary image data corresponding to timings be selected and extracted through the use of the five shutter timings, control means of the server 7 refers to a lookup table representing a correspondence between the frames and stationary image data (step S11).

As a result of referring operation, the type of stationary image data to be sent to the user subsequently is additionally stored in history data pertaining to the past stored in the storage means 22 as individual member history information (step S13). Processing pertaining to step S13 is utilized in the following situation. Namely, if the contestant is determined, from a history about his/her past, to be a user who has selectively input all best shot timings pertaining to motion picture data of certain type, in a phase of updating the history, a giveaway with a super premium is offered to the contestant as a result of input of all best shot timings.

When the updating processing is completed, the control means of the server 7 transmits, to the terminal 4, stationary image data corresponding to the receiving timings at which the selected five shutter timings have been received through input operation.

If input for selecting a shutter timing such as that mentioned above is not performed for a predetermined period of time; e.g., 30 seconds (a time left until playback of a motion picture ends), time-out arises, thereby terminating the virtual photography contest (step S15).

Next, turning again to step S8, in a situation in which the control means of the server 7 has determined that a person who is not an authorized member has made connection with the server 7, when a request for registration of a new member has been made (when YES is selected in step S17), the member registration screen is extracted from the database 25, and the thus-extracted screen is transmitted to the terminal 4 (step S19). If the access is not a request for registration of a new member, the control means of the server 7 forcefully terminates connection with the terminal 4 (step S18).

When the user has finished entry operation on the new member registration screen by way of the input operation 13 of the terminal 4 and the data for which entry has been completed are transmitted to the server 7, the control means of the server 7 determines whether or not entry operation has been performed appropriately (when YES is selected in step S20).

Input information about the member registration screen regarding the member whose registration has been completed is registered in the storage means 22. The control means of the server 7 performs processing such that no overlap exists between the ID code and password of the new member and those of the other members who have already been registered.

As has been described, in the present embodiment, the motion picture data played back by the use of the global network, such as the Internet, are provided to the terminal 4. The thus-offered motion picture data are displayed on the display means 14 of the terminal 4. Input operation (i.e., input of a virtual shutter) is performed at best timings in the motion picture image, thereby selecting frames of motion picture data. A result of selection is subjected to evaluation performed by the control means of the server 7, by reference to the lookup table, in terms of superiority of shutter timing previously prepared for each frame. Stationary image data corresponding to the evaluation result are sent (transmitted) to the terminal 4.

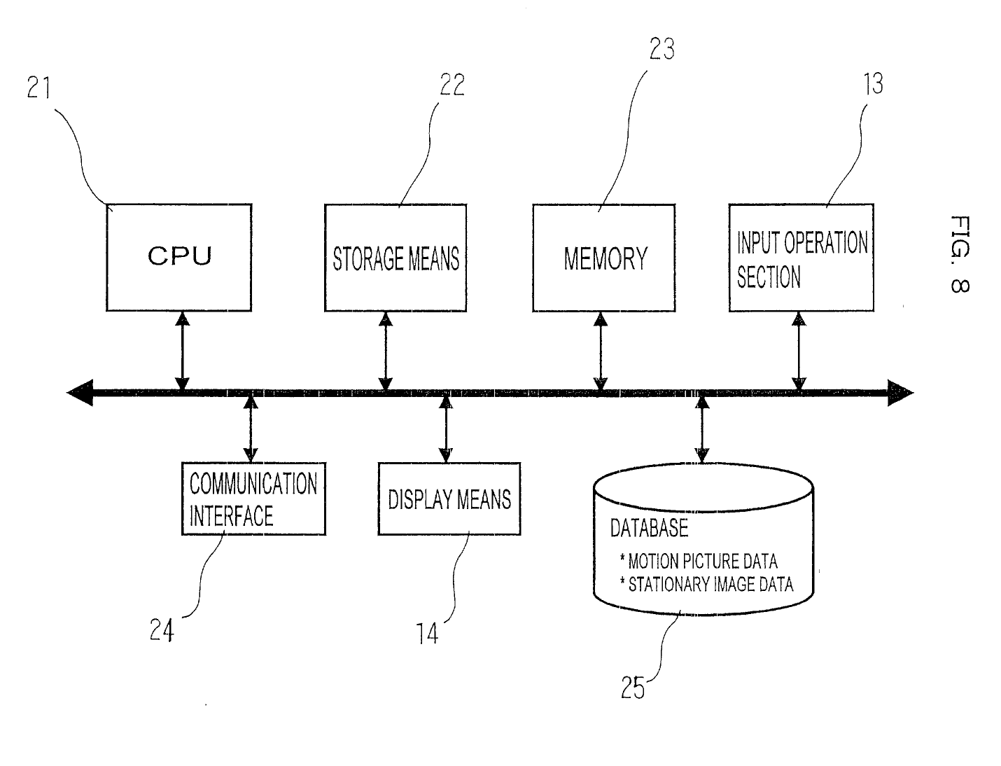

In another embodiment to which the present invention is applied, the present invention can be applied to a gaming machine, such as a seal photographing machine which is equipped with a coin selector and is to be installed in an amusement arcade. FIG. 8 shows a block diagram of a modification of the embodiment in which the present invention is applied to such a gaming machine. As shown in FIG. 8, those elements which are identical in operation with those described previously are assigned the same reference numerals, and repetition of their explanations is omitted.

In this case, when a predetermined value of coins is inserted into an unillustrated coin selector, a game is started in accordance with a program pertaining to a progress in a virtual photography contest. When the game is started, motion pictures based on the motion picture data are displayed on the display means 14 of the terminal 4 in the same manner as mentioned above. The contestant is then provided with an opportunity for performing shutter input operation by way of the input operation section 13 at, e.g., five shutter timings, while viewing the motion picture video.

For each image data frame selected through shutter input operation, a stationary image data set previously assigned to a click point set for a plurality of frames constituting motion picture data is selected from the database 25 and can be stored in a storage medium such as a Floppy Disk (Registered Trademark) or a memory card owned by the user, via a communications interface 24. More specifically, there can be provided a new vender amusement machine which employs image data as giveaways for a game result.

In the above-described embodiment, there are provided stationary image data which are evaluated in accordance with a time required for playing back a playback motion picture and the timing—at which shutter input operation is performed by way of the input operation section—and which correspond to the superiority of a shutter chance of the contestant. Needless to say, there is no necessity for existence of relevance between the stationary image data and motion picture data to be played back. Further, as a matter of course, the design of the amusement machine can be changed so as not to provide stationary image data but to provide motion picture data.

A competition element can also be added to the gaming machine such that, provided that best shot timings of motion picture data have been set by a professional cameraman beforehand, a plurality of contestants are caused to compete with each other for the number of best shots captured from all frames. As a method of causing a plurality of contestants to compete with each other for the number of best shots, it is also feasible to assign points to respective frames beforehand, to add points in a cumulative manner according to shutter timings, and to cause the contestants to compete with each other for superiority of shutter operation in accordance with the number of accumulated points.

Before or after commencement of a virtual photography contest, commentary from a professional cameraman on how to take best shots is transmitted to the terminals 4 as sound, character, or video data. Alternatively, in the case of a stand-alone apparatus such as that shown in FIG. 8, the commentary is displayed on display means of the apparatus, thereby enhancing the game entertainment value.

Addition of an evaluation by a professional cameraman enables realization of a virtual experience gaming machine by means of which a player feels as if having become a professional cameraman.

When a plurality of contestants are caused to compete with each other for best shots by means of their terminals and by way of the global network, the image data provision system can correspond to the WEB server 7 connected to the global network, such as the Internet 6, to which a plurality of the terminals 4, 4, . . . can be connected. In this case, the WEB server 7 has the storage means 22 in which are stored a plurality of receiving timings (shutter timings) pertaining to previously-described motion picture data transmitted from the terminals 4. From among a plurality of receiving timings stored in the storage means 22, the terminal 4 that has transmitted a receiving timing (shutter timing) suitable for predetermined requirements is preferably selected by a selection program previously stored in the storage means 22.

1. An image data provision system comprising:
storage means which stores, in a related manner, motion picture data comprising a plurality of consecutive frames, each of which has an image data set, and stationary image data assigned to at least one of the frames;
display means which plays back the motion picture data stored in the storage means;
input operation means through which a user selects one frame from the frames while the user views the motion picture data shown on the display means; and
control means which can provide the user with the stationary image data assigned to the frame selected through the input operation means.

2. An image data provision system which can send motion picture data and stationary image data through a network in accordance with a remote operation by a user through a terminal, the system comprising:
storage means which stores motion picture data comprising a plurality of consecutive frames, each of which has an image data set, and stationary image data assigned to at least one of the frames;
communication means which sends motion picture data stored in the storage means to the terminal in response to a playback request signal from the terminal such that display means of the terminal displays the motion picture data; and
control means which performs a control operation of making the display means of the terminal display the motion picture data, receiving a selection input signal through the communications means for selecting one frame from the frames, selecting the frame in accordance with the receiving timing of the selection input signal, and transmitting to the terminal the stationary image data previously assigned to the frame.

3. The image data provision system according to claim 1,
wherein the control means performs a control operation for getting a stationary image data set of the stationary image data previously assigned to a frame determined by the selection input signal received from the input operation means through the communication means; and
wherein a number of the stationary data sets is smaller than a number of the frames.

4. The image data provision system according to claim 2,
wherein the control means performs a control operation for getting a stationary image data set of the stationary image data previously assigned to a frame determined by the selection input signal received from the input operation means through the communication means; and
wherein a number of the stationary data sets is smaller than a number of the frames.

5. The image data provision system according to claim 1;
wherein the image data of the frame includes less data than the stationary image data so as to be processed faster.

6. The image data provision system according to claim 2;
wherein the image data of the frame includes less data than the stationary image data so as to be processed faster.

7. The image data provision system according to claim 3;
wherein the image data of the frame includes less data than the stationary image data so as to be processed faster.

8. An image data provision method comprising:
displaying motion picture data comprising a plurality of consecutive frames, each of which corresponds to previously-stored each image data set;
performing an input operation at a desired timing while a user is viewing the motion picture data;
selecting one frame from the frames according to the input operation; and
getting a stationary image data set corresponding to the selected frame from a plurality of stationary image data sets previously-prepared in association with the frames.

9. An image data provision method for transmitting motion picture data and stationary image data through a network in accordance with a remote operation performed by a user through a terminal, the method comprising:
storing motion picture data comprising a plurality of consecutive frames, each of which includes an image data set, and stationary image data assigned to at least one of the frames;
transmitting the motion picture data so that the motion picture data is shown on the terminal in response to a playback request signal from the terminal;
receiving a selection input signal for selecting one frame from the frames while the motion picture data is being shown; and
transmitting to the terminal a stationary image data set of the stationary image data assigned to the selected frame according to a receiving timing of the selection input signal.

10. The image data provision method according to claim 8,
wherein the control means performs a control operation for getting a stationary image data set of the stationary image data previously assigned to a frame determined by the selection input signal received from the input operation means through the communication means; and
wherein a number of the stationary data sets is smaller than a number of the frames.

11. The image data provision method according to claim 9,
wherein the control means performs a control operation for getting a stationary image data set of the stationary image data previously assigned to a frame determined by the selection input signal received from the input operation means through the communication means; and
wherein a number of the stationary data sets is smaller than a number of the frames.

12. The image data provision method according to claim 8,
wherein the image data of the frame includes less data than the stationary image data so as to be processed faster.

13. The image data provision method according to claim 9,
wherein the image data of the frame includes less data than the stationary image data so as to be processed faster.

14. The image data provision method according to claim 10,
wherein the image data of the frame includes less data than the stationary image data so as to be processed faster.

15. The image processing system according to claim 3, comprising a WEB server connected to a network where a plurality of terminals can access;
wherein the WEB server comprises:
storage means which stores a plurality of selection-input-signal-receiving timings transmitted from the terminals; and
control means which selects and processes a terminal that has transmitted a receiving timing matching with a predetermined condition from among the terminals that have transmitted the receiving timings, which are stored in the storage means.

16. An image data provision method for transmitting motion picture data and stationary image data through a network in accordance with a remote operation through a plurality of terminals by at least one user, the method comprising:
storing motion picture data comprising a plurality of consecutive frames, each of which includes an image data set, and stationary image data assigned to at least one of the frames;
transmitting the motion picture data so that the motion picture data is shown on at least one terminal in response to a playback request signal from the terminal;
receiving a selection input signal for selecting one frame from the frames while the motion picture data is being shown on the terminal;
transmitting to the terminal a stationary image data set of the stationary image data assigned to the selected frame according to a receiving timing of the selection input signal; and
storing the receiving timing in relation to the motion picture data;
comparing the stored receiving timing with any one of receiving timings transmitted from the terminals in relation to the motion picture data so that the terminal having transmitted at the most suitable timing for a predetermined condition.
